(19) United States
(12) Patent Application Publication
(10) Pub. No.: US 2008/0229053 A1
(43) Pub. Date: Sep. 18, 2008

(54) Expanding memory support for a processor using virtualization

(76) Inventors: Edoardo Campini, Mesa, AZ (US); Javier Leija, Chandler, AZ (US)

Correspondence Address: TROP PRUNER & HU, PC, 1616 S. VOSS ROAD, SUITE 750, HOUSTON, TX, 77057-2631, US

(21) Appl. No.: 11/717,325

(22) Filed: Mar. 13, 2007

(51) Int. Cl. G06F 12/02

(52) U.S. Cl. 711/203

(57) ABSTRACT

In one embodiment, the present invention includes a system including a processor to access a maximum memory space of a first size using a memory address having a first length, a chipset coupled to the processor to interface the processor to a memory including a physical memory space, where the chipset is to access a maximum memory space larger than the first maximum memory space, and a virtual machine monitor (VMM) to enable the processor to access the full physical memory space of a memory. Other embodiments are described and claimed.

### BACKGROUND

In computer systems, oftentimes components having different capabilities with respect to speed, size, addressing schemes and so forth, are combined in a single system. For example, a chipset, which is a semiconductor device that acts as an interface between a processor and other system components such as memory and input/output devices, may have the capability to address more memory than its paired processor. While this does not prevent the processor/chipset combination from functioning normally, it limits the total maximum system memory to that which is addressable by the processor, versus the larger amount addressable by the chipset (e.g., memory controller). Accordingly, more limited performance occurs than would be available if a larger portion of the memory were accessible to the processor.

### BRIEF DESCRIPTION OF THE DRAWINGS

FIG. 1 is a block diagram of a system in accordance with one embodiment of the present invention.

FIG. 2 is a block diagram of a system in accordance with another embodiment of the present invention.

FIG. 3 is a flow diagram of a method in accordance with an embodiment of the present invention.

### DETAILED DESCRIPTION

In various embodiments, a system may include a processor that can address a smaller memory address space than an associated chipset. To enable improved performance, a virtual machine monitor (VMM) may be used to transparently make a larger, total chipset addressable memory accessible to the processor (without adding any additional hardware). That is, this accessible memory space may be expanded without additional hardware in the nature of bridge chips, segmentation registers or so forth.

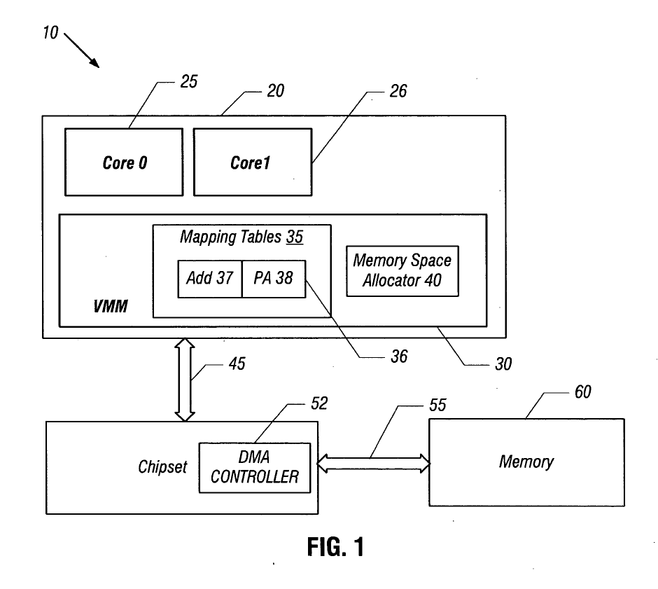

Referring now to FIG. 1, shown is a block diagram of a system in accordance with one embodiment of the present invention. As shown in FIG. 1, system 10 includes a processor 20, which may be a multicore processor including a first core 25 and a second core 26, along with a VMM 30. Of course, in other embodiments a single core processor or a multicore processor including more than two cores may be present. As shown in FIG. 1, VMM 30 includes mapping tables 35 which may be used to map the address space for a given core to the address space of an associated memory. Specifically, as shown in FIG. 1, mapping tables 35 may include a plurality of entries 36, each of which includes a mapping from a core address space 37 to a physical address space 38 of an associated memory. Still further, VMM 30 may include a memory space allocator 40, which may be used to dynamically allocate different amounts of the physical memory to the different cores.

Still referring to FIG. 1, system 10 further includes a chipset 50 coupled to processor 20 by a bus 45, which may be a front side bus (FSB). In other embodiments, however a point-to-point (PTP) or other such interconnect may couple processor 20 and chipset 50. In turn, chipset 50 may be coupled to a memory 60, which may be dynamic random access memory (DRAM) or another such main memory. Chipset 50 is coupled to memory 60 by a bus 55, which may be a memory bus. Chipset 50 may include a direct memory access (DMA) controller 52 which may be DMA controller, an extended DMA (EDMA) controller or other such independent memory controller.

In the embodiment of FIG. 1, processor 20 may be configured to provide addresses on bus 45 using a 32-bit address. Accordingly, processor 20 may only access 4 gigabytes (4 GB) of memory space. However, chipset 50 may include the ability to address memory using, e.g., at least 34 bits, enabling accessing of 16 GB or more of memory space. Furthermore, it may be assumed for purposes of discussion that memory 60 includes 16 GB, such as by presence of four dual in-line memory modules (DIMMs) or single in-line memory modules (SIMMs) or other arrangement of memory devices.

Thus by providing VMM 30 with mapping tables 35 and memory space allocator 40, embodiments may allow system 10, and more particularly the combination of processor 20 and chipset 50 to support the entire 16 GB capability of both chipset 50 and memory 60. Furthermore, such support may be provided without any additional hardware, other than the native processor, chipset and memory itself.

In one embodiment, VMM 30 may use DMA controller 52 of chipset 50 to transparently move data from physical memory within memory 60 that is not directly accessible by either of cores 25 and 26 (i.e., the address space between 4 GB and 16 GB in the FIG. 1 embodiment) into the 4 GB address space that is accessible by the cores. Hence, even though processor 20 can only access a total of 4 GB of memory space, each core 25 and 26 may have access to its own, separate 4 GB (or larger) block of physical memory. In such an implementation, VMM 30 may be responsible for detecting which core is accessing memory, and ensuring that the appropriate data resides within the lower 4 GB address space.

Still further, assuming that chipset 50 supports 16 GB of total memory, VMM 30 may act to evenly provide each core with 8 GB of physical memory, or divide the total 16 GB of physical memory unevenly as dictated by various dynamic parameters, such as priority levels, core usage, thread priorities and so forth. For example, one core could have access to 1 GB, while the second core is given access to 15 GB. In this way, processor privilege levels or processes/tasks may be used to allocate the total 16 GB of physical memory.

As stated above, this method can be used with a software VMM or other virtualization technology without requiring any additional hardware. Furthermore, processor 20 may remain unaware that more than its address space capability is present. That is, processor 20 and the cores therein continue to operate using its standard 32-bit addressing scheme. Accordingly, applications running in various threads on cores 25 and 26 may execute in their original binary form, as no patching or revision to the code is needed to take advantage of the full address space of the physical memory. Accordingly, the full physical memory space is not visible to processor 20 in cores 25 and 26, although it may take full advantage of the entire physical memory by operation of VMM 30.

Embodiments thus enable a processor to access physical memory beyond its native addressability limitations without any additional hardware, providing increased platform performance with no added costs (other than the cost of extra memory). Still further, processor cycles are not needed for moving memory blocks in and out of the processor's physical address space. Instead, the associated chipset, e.g., by way of a memory controller therein, and more particularly a DMA controller such as an EDMA controller, may perform the swapping of memory blocks (which may be as small as page size) from the full physical memory space of the associated memory to the address space accessible to the processor. Thus a processor in a system configuration such as described above may support more memory than its address bus supports natively, without additional hardware.

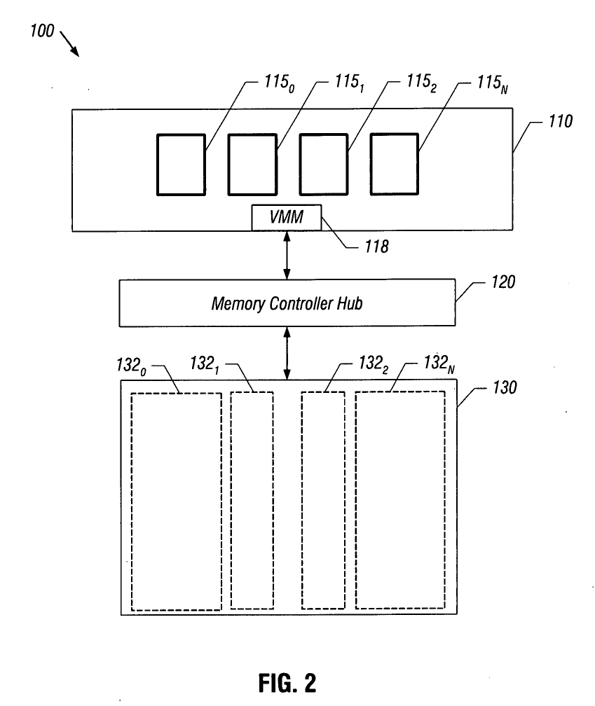

Referring now to FIG. 2, shown is a block diagram of a system in accordance with another embodiment of the present invention. As shown in FIG. 2, system 100 includes a processor 110 including a plurality of cores 115₀-115_{N}. Processor 110 is coupled to a memory controller hub (MCH) 120, which in turn is coupled to a memory 130. As described above, MCH 120 may provide support to address the entire range of physical memory of memory 130, while processor 110 may be more limited in its native addressing capabilities. Accordingly, by VMM 118, which runs on processor 110, each core 115 may be allocated differing amounts of physical memory. For example as shown in FIG. 2, cores 115₀ and 115_{N} may access greater amounts 132₀ and 132_{N} of memory 130 than cores 115₁ and 115₂ (amounts 132₁ and 132₂). VMM 118 may use a DMA controller within MCH 120 to transparently move data from physical memory within memory 130 that is not directly accessible by processor 110 into the memory address space that is accessible by processor 110 (e.g., 0-4 GB). While shown with this particular configuration in the embodiment of FIG. 2 and the allocation of differing amounts of memory to the different cores, it is to be understood the scope of the present invention is not limited in this regard and various other configurations are possible. For example, in different implementations a VMM can allocate memory on a core basis, or the VMM can allocate memory for each privilege level of each core, each thread of each core, each privilege level of each thread for each core, or any combination of these alternatives.

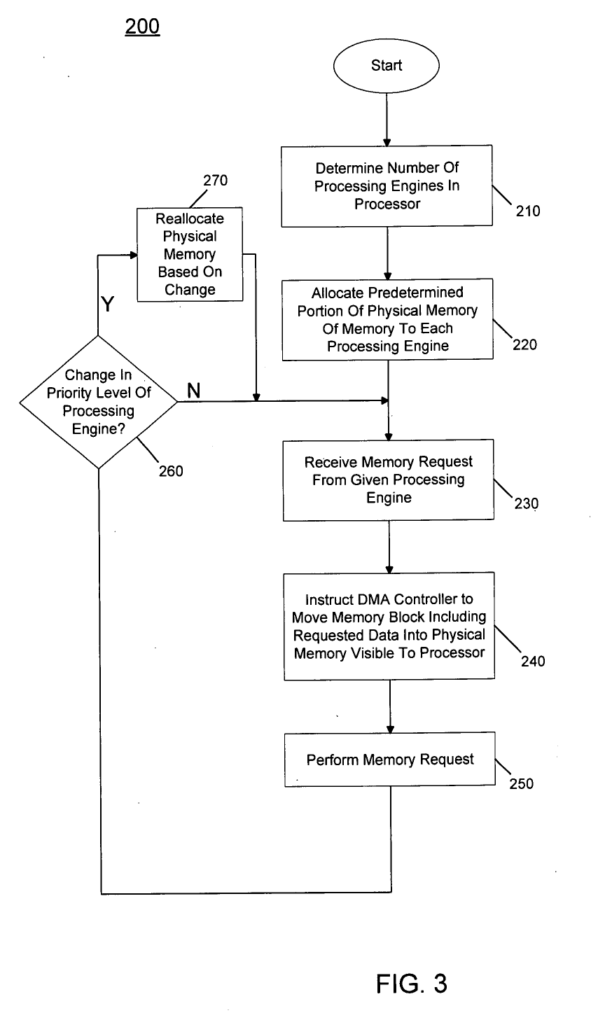

Referring now to FIG. 3, shown is a flow diagram of a method in accordance with an embodiment of the present invention. As shown in FIG. 3, method 200 may be used to allocate and handle memory for multiple processing units, such as cores or other dedicated processing engines of a processor. Referring now to FIG. 3, method 200 begins by determining a number of processing engines in a processor (block 210). For example, a VMM may determine a number of cores or other dedicated processing engines. Then the VMM may allocate a predetermined amount of physical memory to each processing engine (block 220). In one embodiment, the amount of physical memory may correspond to the full address space addressable by the processor for each of multiple engines, assuming sufficient actual physical memory exists.

Then during operation, the VMM may receive requests from a given processing engine for a particular memory access (block 230). Responsive thereto, the VMM may instruct a DMA controller to move the requested memory block that includes the requested data into a portion of the physical memory that is visible to the processor (block 240). Then the memory request may be performed such that the memory may provide via a chipset, the requested data to the processor, for example (block 250).

After handling the memory request, it may be determined whether there is a change in a privilege or priority level of at least one of the processing engines (diamond 260). If not, control may pass to block 230 for handling of another memory request, otherwise control may pass to block 270 for a re-allocation of memory based on the change. For example, different amounts of the physical memory may be allocated to the engines as a result of the change. While shown with the particular implementation in the embodiment of FIG. 3, the scope of the present invention is not limited in this regard; as examples the determinations and allocations performed in FIG. 3 may be on a processor, thread, or other basis.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A system comprising:
a processor to execute instructions, the processor to access a maximum memory space of a first size using a memory address having a first length;
a chipset coupled to the processor to interface the processor to a memory including a physical memory space, wherein the chipset is to access a maximum memory space of a second size using a memory address of a second length, the second size and second length greater than the first size and the first length;
the memory coupled to the chipset having a physical memory space larger than the maximum memory space of the first size; and
a virtual machine monitor (VMM) to enable the processor to access the full physical memory space of the memory.

2. The system of claim 1, where the VMM is executed on the processor.

3. The system of claim 2, wherein the chipset includes an extended direct memory access (EDMA) controller to move blocks of data into and out of the maximum memory space of the first size from another portion of the memory responsive to the VMM.

4. The system of claim 3, wherein the VMM is to instruct the EDMA controller to move data from a portion of the memory addressed beyond the maximum memory space of the first size to a location in the memory of the maximum memory space of the first size.

5. The system of claim 1, wherein the processor includes a first core and second core, wherein the first core and the second core are to access separate blocks of the memory, wherein each of the separate blocks are greater than the maximum memory space of the first size.

6. The system of claim 5, wherein the VMM is to enable the first core to access a greater portion of the memory than the second core.

7. The system of claim 6, wherein the VMM includes a mapping table to map memory addresses of the maximum memory space of the first size to memory addresses in the physical memory space larger than the maximum memory of the first size.

8. The system of claim 7, wherein the VMM further comprises an allocator to dynamically allocate differing amount of the physical memory space to the first and second cores based at least in part on a priority level associated with the first and second cores.

9. A method comprising:
allocating a first portion of a physical memory to a first core of a processor and allocating a second portion of the physical memory to a second core of the processor, wherein the first portion and the second portion are each at least equal to a native memory address space of the processor;
receiving a memory request at a virtual machine monitor (VMM) from the first core; and
instructing a direct memory access (DMA) controller of an interface coupled between the processor and the physical memory to move a memory block including data of the memory request into a portion of the physical memory visible to the first core, the portion of the physical memory visible to the first core corresponding to the native address space of the processor.

10. The method of claim 9, further comprising performing the memory request.

11. The method of claim 9, further comprising determining a number of processing engines in the processor and dynamically allocating different portions of the physical memory to each of the processing engines.

12. The method of claim 11, further comprising re-allocating at least one of the previously allocated portions of the physical memory to a different one of the processing engines if a priority level changes.

13. The method of claim 9, further comprising executing an application on the first core in a native binary form, wherein a portion of the physical memory greater than the native address space of the processor is invisible to the application and the first core, yet accessible thereto via the VMM.

14. The method of claim 9, further comprising extending the memory addressability of the processor using the VMM and without further hardware.
